(19) United States
(12) Patent Application Publication
(10) Pub. No.: US 2011/0044449 A1
(43) Pub. Date: Feb. 24, 2011

(54) PASSWORD DECIPHERING APPARATUS AND METHOD

(75) Inventors: Keonwoo KIM, Daejeon (KR); Do Won Hong, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/615,772

(22) Filed: Nov. 10, 2009

(30) Foreign Application Priority Data
Aug. 19, 2009 (KR) 10-2009-0076841

(51) Int. Cl. H04K 3/00

(52) U.S. Cl. 380/1

(57) ABSTRACT

Provided are an apparatus and a method for deciphering a password. The password deciphering apparatus includes a host control unit and at least two graphic processing units. The host control unit generates candidate passwords for detection of a password of a ciphered document file, and allocates the generated candidate passwords to at least two graphic processing units in a non-overlapping manner. The graphic processing units output password detection information when detecting the password of the document file by searching the allocated candidate passwords. Herein, upon receiving the password detection information from one of the graphic processing units, the host control unit uses the password detection information to detect the password.

### CROSS-REFERENCE TO RELATED APPLICATIONS

This U.S. non-provisional patent application claims priority under 35 U.S.C. §119 of Korean Patent Application No. 10-2009-0076841, filed on Aug. 19, 2009, the entire contents of which are hereby incorporated by reference.

### BACKGROUND OF THE INVENTION

The present invention disclosed herein relates to password deciphering apparatuses, and more particularly, to password deciphering apparatuses and methods capable of reducing the time taken to decipher a password (hereinafter referred to as a password deciphering time).

When generating and distributing a text or image file, a computer user converts the text or image file into a document file (e.g., a PDF file) prior to distribution. In this case, the user may enter a password to cipher the document file in order to protect the contents of the document file and show the document only to an authorized user. In order to open and read the ciphered document file, the user must enter the password that was set to cipher the document file. However, if the user cannot remember the password, he/she cannot open and read the document file. Also, document files ciphered with passwords may be used in a criminal investigation process, but the ciphered document files make it difficult to collect evidences in the criminal investigation process.

A password deciphering software or a dedicated password deciphering hardware is used to detect a password set in a document file.

When using a password searching software, the user can use the software without charge. However, because sequential CPU operations are performed to search the password, the password detection speed is low. Also, when a dedicated password deciphering hardware (e.g., a field-programmable gate array (FPGA) with a deciphering function or an application-specific integrated circuit (ASIC) with a deciphering function) is used to decipher a password, the password can be detected at the highest speed. However, the user must purchase an additional dedicated password searching hardware.

### SUMMARY OF THE INVENTION

Embodiments of the present invention provide password deciphering apparatuses and methods that can reduce a password deciphering time.

Embodiments of the present invention also provide password deciphering apparatuses and methods that can reduce a password deciphering time even without using an additional dedicated password deciphering hardware.

In some embodiments of the present invention, password deciphering apparatuses include: a host control unit generating candidate passwords for detection of a password of a ciphered document file, and allocating the generated candidate passwords to at least two graphic processing units in a non-overlapping manner; and at least two graphic processing units outputting password detection information when detecting the password of the document file by searching the allocated candidate passwords, wherein, upon receiving the password detection information from one of the graphic processing units, the host control unit uses the password detection information to detect the password.

In some embodiments, the graphic processing units perform a password searching operation in parallel from the candidate passwords allocated to each of the graphic processing units.

In other embodiments, the password detection information is start pointer information indicating the start point of the password detected among the candidate passwords corresponding to the product of the number of the blocks allocated to each of the graphic processing units, the number of the threads in the block, and the length of the password.

In further embodiments, the host detects a password from the start point of a string of the candidate passwords to the start point of padding data, and the padding data start from the point with consecutive ASCII code values of ‘0x28’ and ‘0xbf’.

In still further embodiments, the graphic processing units are included in one graphic card or are included respectively in different graphic cards.

In still further embodiments, the host allocates a search range of the password according to the following equation:

for ((i=TOTAL_DOC_THREAD×gpuNumber);

(i<searchEnd+TOTAL_DOC_THREAD×gpuCount);

(i+=TOTAL_DOC_THREAD×gpuCount))

where ‘TOTAL_DOC_THREAD’ denotes the product of the number of the blocks of the graphic processing unit used to decipher the password of the document file and the number of the threads in the block, ‘gpuNumber’ denotes the number of the graphic processing unit, ‘gpuCount’ denotes the number of the graphic processing units used to decipher the password of the ciphered document file, and ‘searchEnd’ denotes the password search range.

In still further embodiments, if using an RC4 algorithm to decipher the ciphered document, the graphic processing unit stores a cipher key generated in a RC4 key generation process and the RC4 data ciphering result in an internal shared memory of the graphic processing unit.

In still further embodiments, at least one of the graphic processing units includes: a graphic processing memory storing the allocated candidate passwords; and a graphic processing control unit searching the allocated candidate passwords to detect a password, and generating the password detection information corresponding to the detected password.

In still further embodiments, the host includes: a host memory storing the candidate passwords; and a host control unit copying the stored candidate passwords into the graphic processing units and obtaining the password of the ciphered document file from the candidate passwords upon receiving the password detection information from one of the graphic processing units.

In still further embodiments, the host memory stores password decipher data for deciphering the password.

In still further embodiments, the host control unit copies the password decipher data into an internal constant memory of the graphic processing memory, and the password decipher data include at least one of Uentry data, Oentry data, IDentry data, Pentry data, and padding data.

In still further embodiments, the host control unit generates the candidate passwords as many as the product of the number of the graphic processing units, the number of the blocks of the graphic processing unit, and the number of the threads of the block.

In still further embodiments, the host processing memory has a size of the product of the number of the graphic processing units, the number of the blocks, the number of the threads, and the length of the password.

In still further embodiments, the host control unit divides a candidate password set with a length of the product of the number of the graphic processing units, the number of the blocks, the number of the threads, and the length of the password by the length of the password and copies the same into a register of the graphic processing memory.

In other embodiments of the present invention, password deciphering methods include: generating candidate passwords by a host; allocating, by the host, the candidate passwords to at least two graphic processing units; searching, by the graphic processing units, a password corresponding to the allocated candidate passwords; generating, by the graphic processing units, password detection information upon detecting a password of a ciphered document file through the password search; and detecting, by the host, a password among the candidate passwords upon receiving the password detection information from one of the graphic processing units.

In some embodiments, the searching of the password includes performing a password searching operation in parallel from the candidate passwords allocated to each of the graphic processing units.

In other embodiments, the password detection information is start pointer information indicating the start point of the password detected among the candidate passwords corresponding to the product of the number of the blocks allocated to each of the graphic processing units, the number of the threads in the block, and the length of the password.

In further embodiments, the detecting of the password among the candidate passwords includes detecting a password from the start point of a string of the candidate passwords to the start point of padding data if the padding data are included in the password, wherein the padding data start from the point with consecutive ASCII code values of ‘0x28’ and ‘0xbf’.

In still further embodiments, the password deciphering methods further include: generating, by the host, the next candidate passwords except the candidate passwords for the password detection when failing to receive the password detection information from one of the graphic processing units.

In still further embodiments, the password deciphering methods further include: copying, by the host, password decipher data for the password search into an internal constant memory of the graphic processing units, wherein the password decipher data include at least one of Uentry data, Oentry data, IDentry data, Pentry data, and padding data.

According to the present invention, the password decipher apparatus uses one or more graphic processing units to decipher a password, thereby reducing a password deciphering time. Also, the password deciphering apparatus uses one or more graphic processing units to decipher a password, thereby reducing a password deciphering time even without using a dedicated password deciphering hardware.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram of a password deciphering apparatus according to an embodiment of the present invention;

FIG. 2 is a block diagram of a graphic processing unit illustrated in FIG. 1;

FIG. 3 is a diagram illustrating a process of copying password decipher data, which are stored in a host memory, into a constant memory of the graphic processing unit according to an embodiment of the present invention;

FIG. 4 is a diagram illustrating a process of copying candidate passwords, which are stored in the host memory, into a register of the graphic processing unit according to an embodiment of the present invention;

FIG. 5 is a diagram illustrating a process of detecting a password from the candidate passwords by a host according to an embodiment of the present invention;

FIG. 6 is a flow chart illustrating an operation of the host according to an embodiment of the present invention;

FIG. 7 is a flow chart illustrating an operation of the graphic processing unit according to an embodiment of the present invention; and

FIG. 8 is a block diagram of a password deciphering apparatus according to another embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, exemplary embodiments of the present invention will be described in detail with reference to the accompanying drawings. In the follow descriptions, a detailed description of well-known functions or configurations will be omitted in order not to unnecessarily obscure subject matters of the present invention.

The present invention provides password deciphering apparatuses and methods that can increase a password deciphering speed.

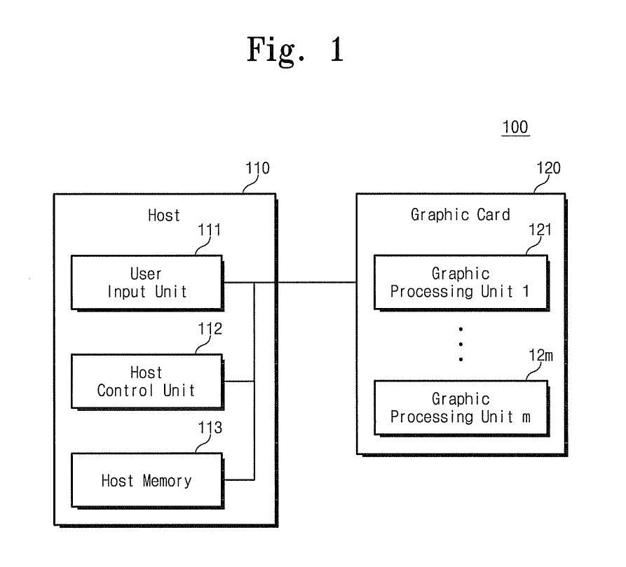

FIG. 1 is a block diagram of a password deciphering apparatus according to an embodiment of the present invention.

Referring to FIG. 1, a password deciphering apparatus 100 includes a host 110 and a graphic card 120. Examples of the password deciphering apparatus 100 include personal computers (PCs) and notebook computers.

The host 110 may decipher a password of a ciphered document file by using graphic processing units 121˜12m included in the graphic card 120. Herein, the password is a security tool that is used to identify an authorized user of the document file.

Examples of the document file include document files with an extension of PDF (i.e., Adobe Acrobat files that are computer program files generated by Adobe systems). Although PDF files are exemplified as document files in this embodiment, the document files may be any other document files that are capable of password setup.

The host 110 uses the graphic card 120 to obtain a password for deciphering a ciphered target document file. The host 110 may perform a password deciphering operation by the graphic card 120 to detect the password at high speed.

The host 110 includes a user input unit 111, a host control unit 112, and a host memory 113. The host 110 may include the graphic card 120 or may be connected to the graphic card 120.

The user input unit 111 interfaces with a user. The user input unit 111 generates password decipher request data according to user input.

The host control unit 112 generates candidate passwords for password decipher according to the password decipher request data. The host control unit 112 generates a candidate password. Herein, the password is one of passwords that are set to cipher a document file.

Equation (1) expresses the total number of candidate passwords (hereinafter also referred to as a candidate password count) that must be searched by the host control unit 112 to detect a password with a maximum length of ‘n’.

$$candidate password ( count ) = \frac{a ( {r}^{n} - 1 )}{r - 1} \qquad ( 1 )$$

where ‘r’ denotes the number of characters usable as a password, ‘a’ denotes the number of strings with a password length of ‘l’, and ‘n’ denotes a password length.

Examples of the characters usable as a password include capital/small alphabets, numerals, and special characters.

The host control unit 112 generates “(the number of blocks)×(the number of threads in the block)×(the number ‘m’ of the graphic processing units)” candidate passwords for each of the graphic processing units 121˜12m of the graphic card 120 at a time. The host control unit 112 generates candidate passwords until obtaining a password through each of the graphic processing units 121˜12m by increasing the number of the candidate passwords by a factor of [(the number of the blocks)×(the number of the threads in the block)×(the number ‘m’ of the graphic processing units)]. Herein, the number of the blocks and the number of the threads in the block vary depending on the performance of the graphic processing units 121˜12m.

The host control unit 112 allocates the generated candidate passwords to the graphic processing units 121˜12m of the graphic card 120. Also, in order to detect a password of a ciphered document file, the host control unit 112 extracts password decipher data from the ciphered document file and provides the password decipher data to the graphic card 120. For example, if the document file is a PDF file, the host control unit 112 extracts Uentry data, Oentry data, IDentry data, and Pentry data. For example, the password decipher data include Uentry data, Oentry data, IDentry data, and Pentry data. Also, the password decipher data further include padding data for forming a predetermined password length.

If the length of candidate passwords is predetermined, the host control unit 112 sequentially fills the candidate passwords with padding data to form the predetermined length of the candidate passwords.

The host memory 113 may store the candidate passwords generated by the host control unit 112. Also, the host memory 113 may store the password decipher data.

The graphic card 120 is allocated the candidate passwords from the host 110. The graphic card 120 detects the password of the ciphered document file from the allocated candidate passwords. The graphic card 120 includes the graphic processing units 121˜12m.

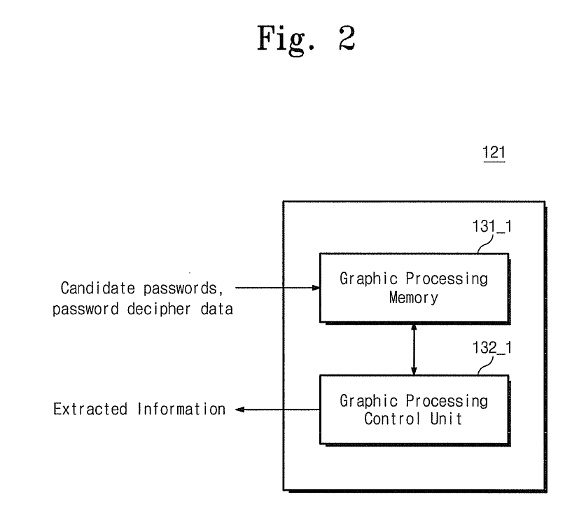

The graphic processing units 121˜12m detects the password of the ciphered document file form the candidate passwords. Upon detecting the password, the graphic processing unit generates password detection information corresponding to the detected password and outputs the password detection information to the host 110. A detailed structure of the graphic processing unit will be described later with reference to FIG. 2.

As described above, when the host control unit 112 uses at least one graphic processing unit (e.g., 121) to decipher a password, a password deciphering speed can be increased due to the parallel processing characteristics of the graphic processing unit. When the host control unit 112 uses at least two graphic processing units (e.g., 121˜12m) to decipher a password, a password deciphering time is further reduced in comparison with the case of using one graphic processing unit (e.g., 121). That is, when the host control unit 112 uses an ‘m’ number of graphic processing units (e.g., 121˜12m) to decipher a password, a password deciphering speed increases by ‘m’ times in comparison with the case of using one graphic processing unit (e.g., 121).

Meanwhile, the host control unit 112 allocates the candidate passwords to the graphic processing units 121˜12m. A candidate password allocation operation of the host control unit 121 will be described below.

For example, it is assumed that the password length is 32 bytes. Also, it is assumed that the number of blocks processible by each of the graphic processing units 121˜12m is 6 and the block is a group of 20 threads. Also, it is assumed that the number ‘m’ of the graphic processing units is 4. In this case, the number of the passwords stored in the host memory 113 at a time is [(the block number ‘6’)×(the thread number ‘20’)×(the graphic processing unit number ‘4’)], and the necessary memory capacity size (e.g., in units of bytes) of the host memory 113 is [(the block number ‘6’)×(the thread number ‘20’)×(the graphic processing unit number ‘4’)×(the password length ‘32’)].

Equation (2) expresses the range of the password allocated to each of the graphic processing units 121˜12m by the host control unit 112.

for ((i=TOTAL_DOC_THREAD×gpuNumber);

(i<searchEnd+TOTAL_DOC_THREAD×gpuCount);

(i+=TOTAL_DOC_THREAD×gpuCount)) (2)

where ‘TOTAL_DOC_THREAD’ denotes the product of the number of the blocks of the graphic processing unit used to decipher the password of the document file and the number of the threads in the block, ‘gpuNumber’ denotes the number of the graphic processing unit, ‘gpuCount’ denotes the number of the graphic processing units used to decipher the password of the document file, and ‘searchEnd’ denotes the password search range.

According to Equation (2), the host control unit 112 generates candidate passwords within the password search range by increasing the number of the candidate passwords in the graphic processing units by a factor of TOTAL_DOC_THREAD.

Herein, it is assumed that ‘gpuNumber’ is 4, ‘TOTAL_DOC_THREAD’ is 120 (=6×20), and ‘searchEnd’ is 1000. Also, it is assumed that the document file is a PDF file and the password for document decipher is the 990^{th} candidate password.

In the first stage, the host control unit 112 may generate and generate candidate passwords to the graphic processing units 121, 122, 123 and 124. That is, the host control unit 112 may allocate the 0^{th} to 119^{th} candidate passwords to the first graphic processing unit 121. The host control unit 112 may allocate the 120^{th} to 239^{th} candidate passwords to the second graphic processing unit 122. The host control unit 112 may allocate the 240^{th} to 359^{th} candidate passwords to the third graphic processing unit 123. The host control unit 112 may allocate the 360^{th} to 479^{th} candidate passwords to the fourth graphic processing unit 124.

In the second stage, if password detection information is not received in the first stage, the host control unit 112 may generate and allocate the next candidate passwords to the graphic processing units 121, 122, 123 and 124. That is, the host control unit 112 may allocate the 480^{th} to 599^{th} candidate passwords to the first graphic processing unit 121. The host control unit 112 may allocate the 600^{th} to 719^{th} candidate passwords to the second graphic processing unit 122. The host control unit 112 may allocate the 720^{th} to 839^{th} candidate passwords to the third graphic processing unit 123. The host control unit 112 may allocate the 840^{th} to 959^{th} candidate passwords to the fourth graphic processing unit 124.

In the third stage, if password detection information is not received in the second stage, the host control unit 112 may generate and allocate the next candidate passwords to the graphic processing units 121, 122, 123 and 124. That is, the host control unit 112 may allocate the 960^{th} to 1079^{th} candidate passwords to the first graphic processing unit 121. The host control unit 112 may allocate the 1080^{th} to 1199^{th} candidate passwords to the second graphic processing unit 122. The host control unit 112 may allocate the 1200^{th} to 1319^{th} candidate passwords to the third graphic processing unit 123. The host control unit 112 may allocate the 1320^{th} to 1439^{th} candidate passwords to the fourth graphic processing unit 124.

If the 990^{th} candidate password is the password of the ciphered document file, the host control unit 112 may obtain the password detection information from the first graphic processing unit 121. For example, the password detection information may be information about the start point of the 990^{th} candidate password.

Meanwhile, because the graphic processing units 121, 122, 123 and 124 operate simultaneously, the search ranges thereof may be interchangeable.

That is, the host control unit 112 may perform the following operation in the third stage.

If password detection information is not received in the second stage, the host control unit 112 may generate and allocate the next candidate passwords to the graphic processing units 121, 122, 123 and 124.

The host control unit 112 may allocate the 1080^{th} to 1199^{th} candidate passwords to the first graphic processing unit 121. The host control unit 112 may allocate the 1320^{th} to 1439^{th} candidate passwords to the second graphic processing unit 122. The host control unit 112 may allocate the 960^{th} to 1079^{th} candidate passwords to the third graphic processing unit 123. The host control unit 112 may allocate the 1200^{th} to 1319^{th} candidate passwords to the fourth graphic processing unit 124.

If the 990^{th} candidate password is the password of the ciphered document file, the host control unit 112 may obtain password detection information from the third graphic processing unit 123. For example, the password detection information may be information about the start point of the 990^{th} candidate password.

When receiving the password detection information, the host control unit 112 may stop generating the next candidate passwords.

As described above, if there are a plurality of graphic processing units, the host control unit 112 allocates the candidate passwords to the graphic processing units in a non-overlapping manner. Also, the password searches, which use the candidate passwords allocated to the graphic processing units 121, 122, 123 and 124, are performed in parallel.

In this manner, when using at least two graphic processing units of the graphic card 120 to decipher the password, the host 110 can decipher the password more rapidly than the case of using one graphic processing unit to decipher the password.

FIG. 2 is a block diagram of the graphic processing unit illustrated in FIG. 1.

Referring to FIG. 2, the first graphic processing unit 121 includes a first graphic processing memory 131_1 and a first graphic processing control unit 132_1.

The first graphic processing control unit 132_1 receives the candidate passwords. Also, the first graphic processing control unit 132_1 receives the password decipher data. For example, the password decipher data include Uentry data, Oentry data, IDentry data, Pentry data, and padding data.

The first graphic processing control unit 132_1 may use an RC4 algorithm or an MD5 algorithm for password detection.

A description will be given of an exemplary case of using an RC4 algorithm for password detection.

For example, an RC 4 ciphering algorithm generates a ciphertext by XORing a plaintext and a key stream derived from a secret key.

The first graphic processing control unit 132_1 obtains Uentry data by applying a candidate password, Oentry data, IDentry data, and Pentry data to an RC4 algorithm.

The first graphic processing control unit 132_1 determines whether the Uentry data extracted from the ciphered document data are equal to the Uentry data obtained from the candidate password. If the Uentry data extracted from the ciphered document data are equal to the Uentry data obtained from the candidate password, the first graphic processing control unit 132_1 detects the corresponding candidate password as the password.

The first graphic processing control unit 132_1 searches the candidate passwords to detect the password. If detecting the password, the first graphic processing control unit 132_1 transmits the password detection information to the host 110. Herein, the password detection information may include the location information of the password detected for document read among all the candidate passwords (e.g., the number of the blocks×the number of the threads). That is, the password detection information may include information about the start pointer of the detected password among the candidate passwords (i.e., information about the location order of the detected password among the candidate passwords).

The graphic processing unit 121 uses a shared memory for password search in order to efficiently use the resource of the internal graphic processing memory 131_1. For example, the shared memory may be a partial area of the graphic processing memory 131_1. The graphic processing control unit 132_1 uses an inputted key buffer to generate a new cipher key in an RC4 key generation stage before RC4 data ciphering, wherein the generated new cipher key is stored in the shared memory. Also, in an actual ciphering process, the graphic processing control unit 132_1 uses the cipher key stored in the shared memory. Also, in an RC4 ciphering operation, the graphic processing control unit 132_1 ciphers plaintext input data to store the ciphering result in the shared memory to use the result value in a PDF password search mechanism. Herein, the shared memory is an on-chip memory shared in each block, and has a very high access speed. That is, the shared memory (instead of a storage space such as a register or a constant memory) is used as a memory resource necessary for storage of the cipher key and ciphering result for use of RC4.

Meanwhile, the first graphic processing control unit 132_1 may exchange host control information (e.g., password search start or password search end) with the host control unit 112. The second to m^{th} graphic processing units 122 to 12m may have the same structure as the first graphic processing unit 121.

Thus, the second graphic processing unit 122 may include a second graphic processing memory 131_2 and a second graphic processing control unit 132_2, and the m^{th} graphic processing unit 12m may include an m^{th} graphic processing memory 131_{—}m and an m^{th} graphic processing control unit 132_{—}m.

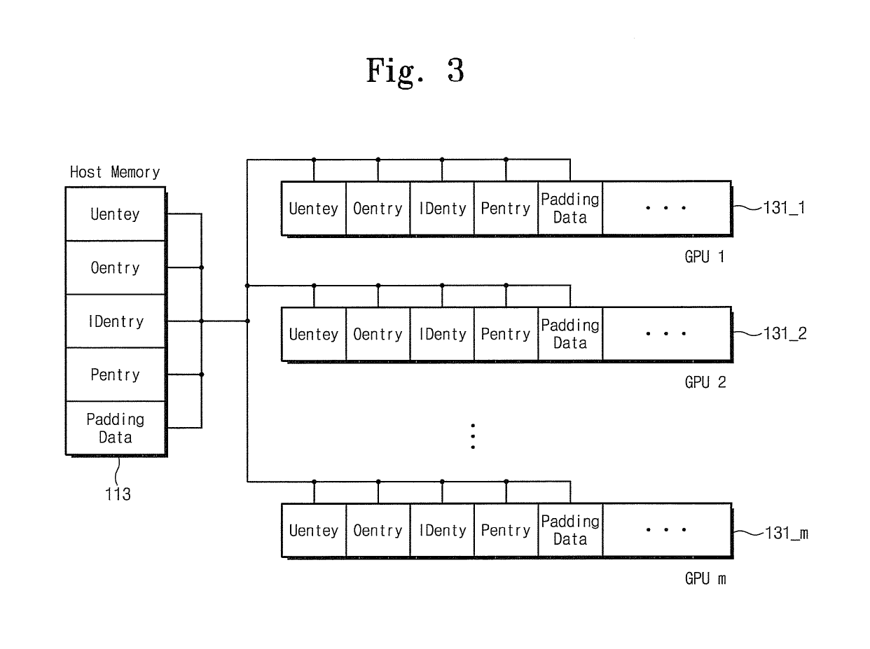

FIG. 3 is a diagram illustrating a process of copying the password decipher data, which are stored in the host memory, into a constant memory of the graphic processing unit according to an embodiment of the present invention.

Referring to FIG. 3, under the control of the host control unit 112, the password decipher data of the host memory 113 are copied into the constant memories in the first to m^{th} graphic processing memories 131_1, 131_2, . . . , 131_{—}m.

For example, the password decipher data copied into the constant memory in each of the graphic processing memories 131_1, 131_2, . . . , 131_{—}m include Uentry data, Gentry data, IDentry data, Pentry data, and padding data. For example, the Uentry data may be comprised of 32 bytes. The Gentry data may be comprised of 32 bytes. The IDentry data may be comprised of 16 bytes. The Pentry data may be comprised of 4 bytes. The padding data may be comprised of 32 bytes. The Uentry data, the Oentry data, the IDentry data, and the Pentry data are used to decipher the password of the document file.

Meanwhile, it is assumed that the length of the candidate password for detection of the password of the document file is 32 bytes. In this case, the padding data are used to convert a password of less than 32 bytes into a 32-byte password.

For example, the padding data may include ‘0x28, 0xbf, 0x4e, 0x5e, 0x4e, 0x75, 0x8a, 0x41, 0x64, 0x00, 0x4e, 0x56, 0xff, 0xfa, 0x01, 0x08, 0x2e, 0x2e, 0x00, 0xb6, 0xD0, 0x68, 0x3e, 0x80, 0x2f, 0x0c, 0xa9, 0xfe, 0x64, 0x53, 0x69, 0x7a’.

Meanwhile, it is assumed that the total password length is set to be smaller than 32 bytes.

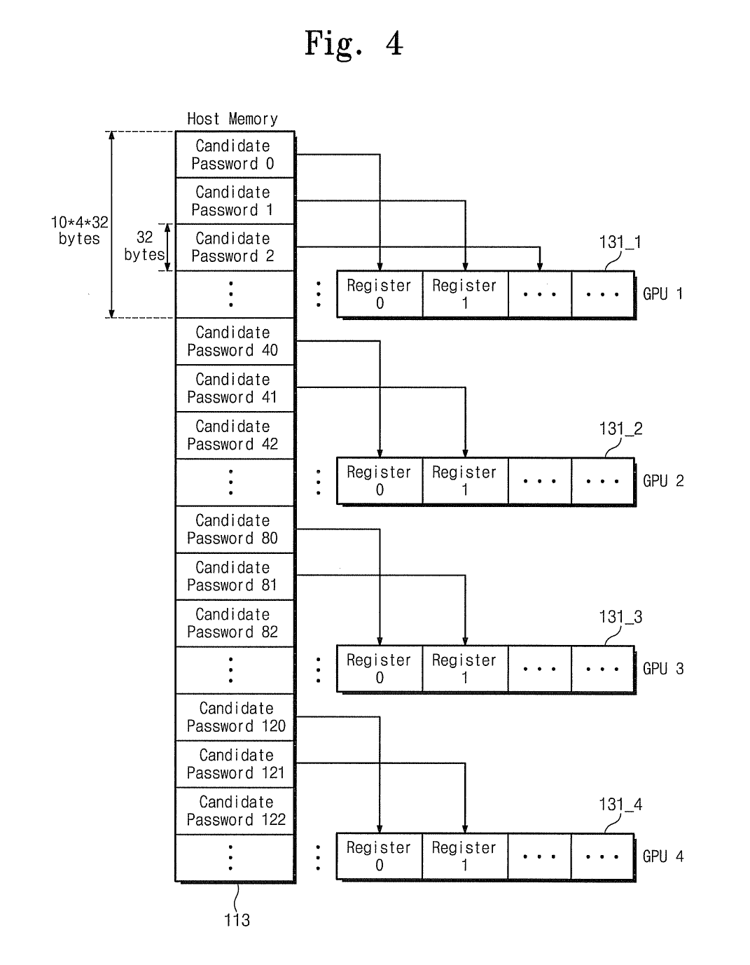

FIG. 4 is a diagram illustrating a process of copying the candidate passwords, which are stored in the host memory, into a register of the graphic processing unit according to an embodiment of the present invention.

Referring to FIG. 4, under the control of the host control unit 112, the candidate passwords of the host memory 113 are copied into the registers in the first to m^{th} graphic processing memories 131_1, 131_2, . . . , 131_{—}m.

It is assumed that there are four graphic processing units 121 to 124. Herein, the graphic processing units 121 to 124 may be included in one graphic card or at least two graphic cards.

Also, it is assumed that each of the graphic processing units 121 to 124 processes 10 blocks. Also, it is assumed that each of the 10 blocks includes 4 threads.

The host control unit 112 may generate candidate passwords as many as [(the block number ‘10’)×(the thread number ‘4’)×(the graphic processing unit number ‘4’)]. The generated candidate passwords (i.e., the candidate passwords 0 to 159) are stored in the host memory 113.

The candidate passwords 0, 40, 80 and 120, stored in the host memory 113 by the host control unit 112, are stored in the internal registers 0 of the first to fourth graphic processing units 121 to 124 (i.e., some portions of the storage sites of the graphic processing memories 131_1, 131_2, 131_3 and 131_4 used as resisters).

The candidate passwords 1, 41, 81 and 121, stored in the host memory 113 by the host control unit 112, are stored in the internal registers 1 of the first to fourth graphic processing units 121 to 124 (i.e., other portions of the storage sites of the graphic processing memories 131_1, 131_2, 131_3 and 131_4 used as resisters).

The candidate passwords 2, 42, 82 and 122, stored in the host memory 113 by the host control unit 112, are stored in the internal registers 2 of the first to fourth graphic processing units 121 to 124 (i.e., other portions of the storage sites of the graphic processing memories 131_1, 131_2, 131_3 and 131_4 used as resisters).

The candidate passwords 3, 43, 83 and 123, stored in the host memory 113 by the host control unit 112, are stored in the internal registers 3 of the first to fourth graphic processing units 121 to 124 (i.e., other portions of the storage sites of the graphic processing memories 131_1, 131_2, 131_3 and 131_4 used as resisters).

The candidate passwords of the host memory 113 are divided by the length of the candidate password and are copied into the respective registers of the graphic processing units 121 to 124 in distributed manner.

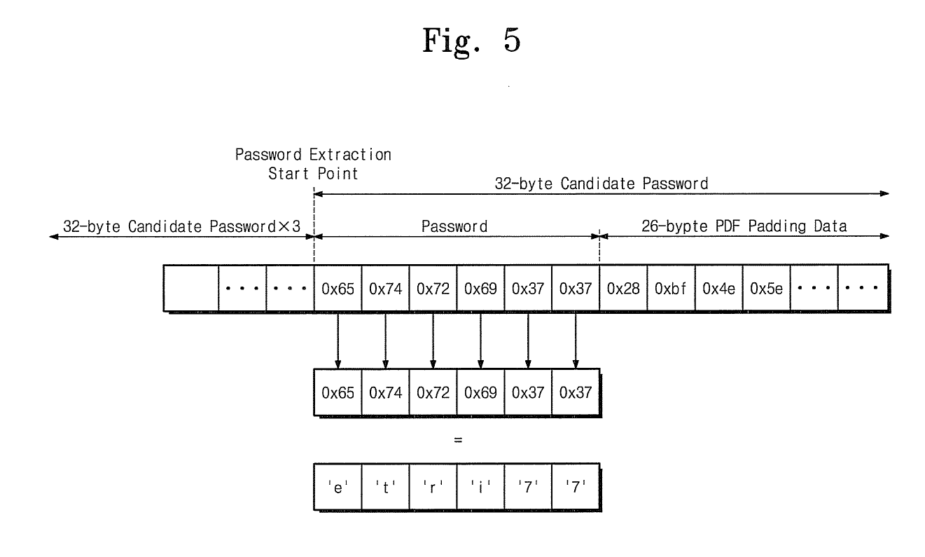

FIG. 5 is a diagram illustrating a process of detecting the password from the candidate passwords by the host according to an embodiment of the present invention.

Referring to FIG. 5, a password of a document file is selected from values 0x20 to 0x7f among ASCII code hexadecimal values. For example, it is assumed that the password of the document file is set to 32 bytes. If the size of a candidate password is smaller than 32 bytes, the host control unit 112 adds padding data to the candidate password to generate a 32-byte candidate password.

For example, when detecting a password of a PDF file, the graphic processing unit (e.g., 121), transmits password detection information to the host control unit 112. Herein, the password detection information is used to notify the host control unit 112 from which of the candidate passwords stored the register of the graphic processing unit 121 the correct candidate passwords start. The number of the candidate passwords stored in the graphic processing unit 121 is equal to [(the number of the blocks)×(the number of the threads in the block)]. Also, the graphic processing unit 121 is one of the graphic processing units 121˜12m.

The host control unit 112 uses the password detection information to extract an actual password from a string of the candidate passwords allocated to the graphic processing unit 121 among the candidate passwords of the host memory 113. Herein, the candidate passwords of the host memory 113 have a size of [(the number of the graphic processing units)×(the number of the blocks)×(the number of the threads in the block)].

Consequently, the host control unit 112 has the same password string as the register of the graphic processing unit 121. Thus, the host control unit 112 can extract actual password characters by using the password start pointer obtained from the password detection information.

For example, it is assumed that the host control unit 112 allocates three consecutive 32-byte candidate passwords to one graphic processing unit (e.g., 121) and then allocates 32-byte candidate passwords comprised of ‘0x65, 0x74, 0x72, 0x69, 0x37, 0x37, 0x28, 0xbf, 0x4e, 0x5e, . . . ’.

In this case, if the password detection information received from the graphic processing unit 121 is a start pointer of 3, the host control unit 112 detects the fourth candidate password. That is, for example, the start points of the three consecutive candidate passwords are ‘0’, ‘1’ and ‘2’, and the start point of the fourth candidate password is ‘3’. Therefore, for example, the host control unit 112 detects the password in the fourth candidate password up to the start point with consecutive padding data of ‘0x28 ’ and ‘0xbf’. That is, the host control unit 112 removes the padding data from the candidate password. In this case, the host control unit 112 detects an ASCII code password ‘0x65, 0x74, 0x72, 0x69, 0x37, 0x37’. Herein, for example, the detected password value is ‘e’, ‘t’, ‘r’, ‘i’, ‘7’, ‘7’.

The host control unit 112 uses the detected password to receive the authority to access the ciphered file.

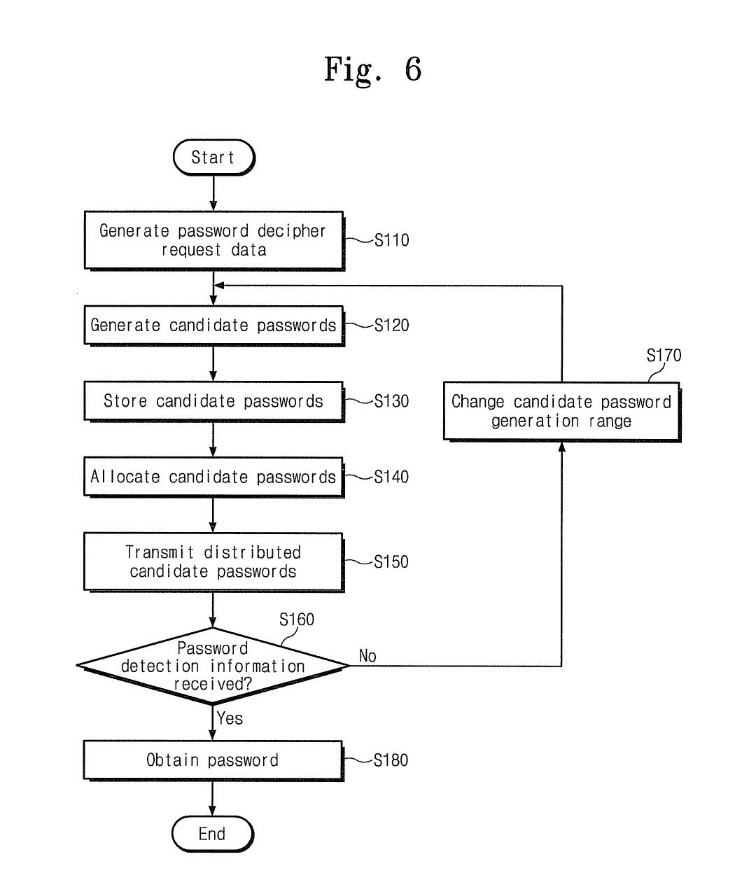

FIG. 6 is a flow chart illustrating an operation of the host according to an embodiment of the present invention.

Referring to FIG. 6, the user input unit 111 generates password decipher request data in step S110.

In step S120, the host control unit 112 generates candidate passwords corresponding to the password decipher request data. The host control unit 112 generates some of all the candidate passwords in consideration of the number of the graphic processing units 121˜12m, the number of the blocks, and the number of the threads in the block.

In step S130, the host control unit 112 stores the generated candidate passwords in the host memory 113.

In step S140, the host control unit 112 distributes the candidate passwords to at least two graphic processing units. The host control unit 112 distributes the candidate passwords to the graphic processing units in consideration of the number of the blocks, the number of the threads in the block, and the number of the graphic processing units. The host control unit 112 distributes the candidate passwords to the graphic processing units in a non-overlapping manner.

In step S150, the host control unit 112 transmits the distributed candidate passwords to the graphic processing units.

In step S160, the host control unit 112 determines whether the password detection information is received. If the password detection information is not received (in step S160), the host control unit 112 proceeds to step S170.

In step S170, in order to generate the next candidate passwords among all the candidate passwords, the host control unit 112 changes the candidate password generation range and returns to step S120.

If the password detection information is received (in step S160), the host control unit 112 proceeds to step S180.

In step S180, the host control unit 112 detects a password among the candidate passwords stored in the host memory 113. For example, the password detection information is the start pointer value of the password detected among the candidate passwords.

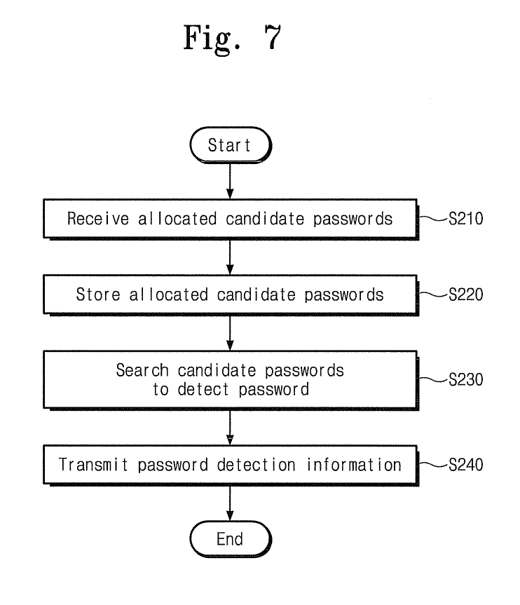

FIG. 7 is a flow chart illustrating an operation of the graphic processing unit according to an embodiment of the present invention.

Referring to FIG. 7, the graphic processing unit 121 receives the distributed candidate passwords in step S210.

In step S220, the graphic processing unit 121 stores the distributed candidate passwords.

In step S230, the graphic processing unit 121 searches the candidate passwords to detect a password. When detecting the candidate passwords, the graphic processing unit 121 compares the first password search information extracted from the ciphered document file with the second password search information generated using the candidate passwords. If the first password search information is equal to the second password search information, the graphic processing unit 121 detects the corresponding candidate password as the password. For example, if an RC4 algorithm is used for password search, the first password search information and the second password search information may be Uentry information.

In step S240, the graphic processing unit 121 generates password detection information corresponding to the detected password and outputs the password detection information to the host 110.

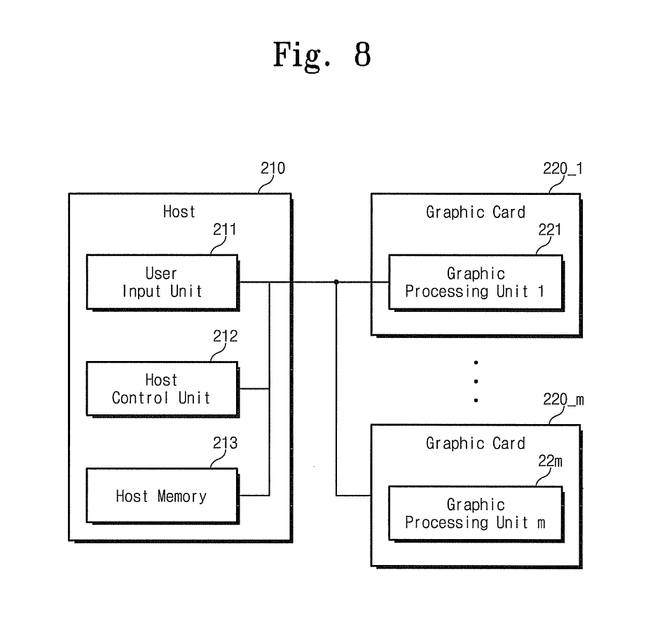

FIG. 8 is a block diagram of a password deciphering apparatus according to another embodiment of the present invention.

Referring to FIG. 8, a password deciphering apparatus 200 includes a host 110 and a plurality of graphic cards 220_1˜220_{—}m.

The graphic cards 220_1˜220_{—}m are connected to the host 110. The first graphic card 220_1 includes a first graphic processing unit 221. The m^{th} graphic card 220m includes an m^{th} graphic processing unit 22m.

The password deciphering apparatus 200 of FIG. 8 is configured to include one graphic processing unit in one graphic card. The operation and configuration of the password deciphering apparatus 200 of FIG. 8 are similar to the operation and configuration of the password deciphering apparatus 100 of FIG. 1 with the exception that one graphic processing unit is included in one graphic card. Thus, a detailed description of the password deciphering apparatus 200 of FIG. 8 will be omitted for conciseness.

Although FIGS. 1 and 8 illustrate that the host and the graphic card are separate from each other, at least one graphic card may be included in the host.

As described above, according to the present invention, the password decipher apparatus uses a plurality of graphic processing units to detect a password for password decipher, thereby reducing a password deciphering time. That is, when using a plurality of graphic processing units to detect a password, the password deciphering apparatus can further reduce a password deciphering time in comparison with the case or using one graphic processing unit to detect a password.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A password deciphering apparatus comprising:
a host control unit generating candidate passwords for detection of a password of a ciphered document file, and allocating the generated candidate passwords to at least two graphic processing units in a non-overlapping manner; and
at least two graphic processing units outputting password detection information when detecting the password of the document file by searching the allocated candidate passwords,
wherein, upon receiving the password detection information from one of the graphic processing units, the host control unit uses the password detection information to detect the password.

2. The password deciphering apparatus of claim 1, wherein the graphic processing units perform a password searching operation in parallel from the candidate passwords allocated to each of the graphic processing units.

3. The password deciphering apparatus of claim 1, wherein the password detection information is start pointer information indicating the start point of the password detected among the candidate passwords corresponding to the product of the number of the blocks allocated to each of the graphic processing units, the number of the threads in the block, and the length of the password.

4. The password deciphering apparatus of claim 3, wherein the host detects a password from the start point of a string of the candidate passwords to the start point of padding data, and the padding data start from the point with consecutive ASCII code values of ‘0x28’ and ‘0xbf’.

5. The password deciphering apparatus of claim 1, wherein the graphic processing units are included in one graphic card or are included respectively in different graphic cards.

6. The password deciphering apparatus of claim 1, wherein the host allocates a search range of the password according to the following equation:
for ((i=TOTAL_DOC_THREAD×gpuNumber);
(i<searchEnd+TOTAL_DOC_THREAD×gpuCount);
(i+=TOTAL_DOC_THREAD×gpuCount))
where ‘TOTAL_DOC_THREAD’ denotes the product of the number of the blocks of the graphic processing unit used to decipher the password of the document file and the number of the threads in the block, ‘gpuNumber’ denotes the number of the graphic processing unit, ‘gpuCount’ denotes the number of the graphic processing units used to decipher the password of the ciphered document file, and ‘searchEnd’ denotes the password search range.

7. The password deciphering apparatus of claim 1, wherein if using an RC4 algorithm to decipher the ciphered document, the graphic processing unit stores a cipher key generated in a RC4 key generation process and the RC4 data ciphering result in an internal shared memory of the graphic processing unit.

8. The password deciphering apparatus of claim 1, wherein at least one of the graphic processing units comprises:
a graphic processing memory storing the allocated candidate passwords; and
a graphic processing control unit searching the allocated candidate passwords to detect a password, and generating the password detection information corresponding to the detected password.

9. The password deciphering apparatus of claim 8, wherein the host comprises:
a host memory storing the candidate passwords; and
a host control unit copying the stored candidate passwords into the graphic processing units and obtaining the password of the ciphered document file from the candidate passwords upon receiving the password detection information from one of the graphic processing units.

10. The password deciphering apparatus of claim 9, wherein the host memory stores password decipher data for deciphering the password.

11. The password deciphering apparatus of claim 10, wherein the host control unit copies the password decipher data into an internal constant memory of the graphic processing memory, and the password decipher data include at least one of Uentry data, Gentry data, IDentry data, Pentry data, and padding data.

12. The password deciphering apparatus of claim 7, wherein the host control unit generates the candidate passwords as many as the product of the number of the graphic processing units, the number of the blocks of the graphic processing unit, and the number of the threads of the block.

13. The password deciphering apparatus of claim 12, wherein the host processing memory has a size of the product of the number of the graphic processing units, the number of the blocks, the number of the threads, and the length of the password.

14. The password deciphering apparatus of claim 12, wherein the host control unit divides a candidate password set with a length of the product of the number of the graphic processing units, the number of the blocks, the number of the threads, and the length of the password by the length of the password and copies the same into a register of the graphic processing memory.

15. A password deciphering method comprising:
generating candidate passwords by a host;
allocating, by the host, the candidate passwords to at least two graphic processing units;
searching, by the graphic processing units, a password corresponding to the allocated candidate passwords;
generating, by the graphic processing units, password detection information upon detecting a password of a ciphered document file through the password search; and
detecting, by the host, a password among the candidate passwords upon receiving the password detection information from one of the graphic processing units.

16. The password deciphering method of claim 15, wherein the searching of the password comprises performing a password searching operation in parallel from the candidate passwords allocated to each of the graphic processing units.

17. The password deciphering method of claim 15, wherein the password detection information is start pointer information indicating the start point of the password detected among the candidate passwords corresponding to the product of the number of the blocks allocated to each of the graphic processing units, the number of the threads in the block, and the length of the password.

18. The password deciphering method of claim 17, wherein the detecting of the password among the candidate passwords comprises detecting a password from the start point of a string of the candidate passwords to the start point of padding data if the padding data are included in the password,
wherein the padding data start from the point with consecutive ASCII code values of ‘0x28’ and ‘0xbf’.

19. The password deciphering method of claim 15, further comprising:
generating, by the host, the next candidate passwords except the candidate passwords for the password detection when failing to receive the password detection information from one of the graphic processing units.

20. The password deciphering method of claim 15, further comprising:
copying, by the host, password decipher data for the password search into an internal constant memory of the graphic processing units,
wherein the password decipher data include at least one of Uentry data, Oentry data, IDentry data, Pentry data, and padding data.
